(19) United States
(12) Patent Application Publication
(10) Pub. No.: US 2020/0320314 A1
(43) Pub. Date: Oct. 8, 2020

(54) ROAD OBJECT RECOGNITION METHOD AND DEVICE USING STEREO CAMERA

(71) Applicant: VISION ST CO., LTD., Seoul (KR)

(72) Inventors: Jung Gu KIM, (US); Ja Cheol Koo, Seoul (KR); Jae Hyung YOO, (US)

(73) Assignee: VISION ST., CO., LTD., Seoul (KR)

(21) Appl. No.: 16/303,986

(22) PCT Filed: Oct. 19, 2017
(86) PCT No.: PCT/KR2017/011598

§ 371 Date: Nov. 21, 2018

(51) Int. Cl. G06K 9/00

(52) U.S. Cl. CPC G06K 9/00798; G06K 9/00818

(57) ABSTRACT

Provided are road object recognition method and apparatus using a stereo camera, and the road object recognition method using a stereo camera includes a road image acquisition step of acquiring a road image by using the stereo camera, a road surface recognition and separation step of recognizing a road surface from the acquired road image and separating the road surface, and a road object recognition step of recognizing a road object from the separated road surface. According to the road object recognition method and apparatus using the stereo camera, in a state in which a front traveling vehicle is included, a road surface is recognized from a road image acquired using the stereo camera and is separated, so that it is possible to effectively recognize objects on the recognized road surface.

### BACKGROUND

### 1. Technical Field

The present disclosure relates to a method and an apparatus, by which an autonomous vehicle recognizes a road surface object such as a lane, a stop line, a crosswalk, and a direction indicator line from main data required for autonomous driving, and more particularly, to road object recognition method and apparatus using a stereo camera, by which it is possible to separate a road surface from an input image by using a realtime binocular stereo camera and to effectively recognize a road surface object from the separated road image.

### 2. Related Art

An autonomous vehicle is a vehicle which is automatically driven by a computer, instead of a person, and safely moves to a destination while recognizing surrounding environments of the vehicle and a road surface in realtime by utilizing a camera, a radar, ultrasonic waves, and various sensors such as a GPS.

A driver rides in the autonomous vehicle, but the computer installed at the vehicle drives the vehicle like a person while recognizing the surrounding environments of the vehicle in realtime by using various sensors mounted at the vehicle. At the present time, the autonomous vehicle is researched and developed by many worldwide automobile manufacturing companies that use much cost and a lot of manpower as well as software-based information technology (IT) companies such as Google and Apple.

When a person drives a vehicle, the driver quickly recognizes the surrounding environments of the vehicle with his/her both eyes and acquires information required for driving in realtime. Since the vehicle actually moves in a three-dimensional space at a high speed, it is very important and absolutely necessary to accurately acquire three-dimensional information on the surrounding of the vehicle. Particularly, recognizing various objects displayed on a road such as a lane, a stop line, a direction indicator line, and a crosswalk from an image including other vehicles being run and the road is basic and important to acquire information required for autonomous driving.

When there is only a road, since many methods for recognizing objects printed on the road surface have been developed, there is no special difficulty in recognizing the objects. However, when objects on a road should be recognized from an image including front vehicles being run, it is difficult to accurately recognize the objects because the road is hidden by the vehicles.

### SUMMARY

Various embodiments are directed to road object recognition method and apparatus using a stereo camera, by which it is possible to recognize a road surface from a road image by using the stereo camera, remove information other than the road surface, and recognize objects on a road through an algorithm for recognizing road objects from an image including only the road surface.

In an embodiment, a road object recognition method using a stereo camera according to the present invention may include a road image acquisition step of acquiring a road image by using the stereo camera, a road surface recognition and separation step of recognizing a road surface from the acquired road image and separating the road surface, and a road object recognition step of recognizing a road object from the separated road surface.

In an embodiment, a road object recognition apparatus using a stereo camera according to the present invention may include the stereo camera, a road image acquisition unit that acquires a road image by using the stereo camera, a road surface recognition and separation unit that recognizes a road surface from the acquired road image and separates the road surface, and a road object recognition unit that recognizes a road object from the separated road surface.

In accordance with the road object recognition method and apparatus using a stereo camera according to the present invention, in a state in which a front traveling vehicle is included, a road surface is recognized from a road image acquired using the stereo camera and is separated, so that it is possible to effectively recognize objects on the recognized road surface.

In a road image obtained by capturing a road by using an existing monocular camera, when there is a front vehicle being run, since the front vehicle hides a part of the road, there may occur an error in recognizing objects on the road. However, in the case of using the stereo camera as with the present invention, a vehicle is separated from a road by using a disparity map, a road surface is recognized, and then objects on the road are recognized, so that it is possible to recognize the objects on the road similarly to a process in which a person recognizes the objects on the road.

### BRIEF DESCRIPTION OF THE DRAWINGS

FIG. 1 is a conceptual diagram illustrating a process of a road object recognition method using a stereo camera according to the present invention.

FIG. 2 is a detailed block diagram illustrating a process of a road object recognition method using a stereo camera according to the present invention.

FIG. 3 is a diagram illustrating a stereo camera of a road object recognition apparatus according to the present invention and images acquired from the stereo camera.

FIG. 4 is a diagram illustrating output images of a stereo camera of a road object recognition apparatus according to the present invention and images obtained by separating a road surface.

FIG. 5 is a block diagram of an adaptive binarization calculation applied to a road object recognition method using a stereo camera according to the present invention and a diagram illustrating an example applied to an image.

FIG. 6 is a diagram illustrating recognition of a lane using a RANSAC algorithm in a road object recognition method using a stereo camera according to the present invention.

FIG. 7 is a diagram illustrating an example in which road objects are recognized by a road object recognition method using a stereo camera according to the present invention.

FIG. 8 is a diagram illustrating left and right images of a road acquired from various road environments by using a stereo camera and a disparity map.

### DETAILED DESCRIPTION

Exemplary embodiments will be described below in more detail with reference to the accompanying drawings. The disclosure may, however, be embodied in different forms and should not be constructed as limited to the embodiments set forth herein. Rather, these embodiments are provided so that this disclosure will be thorough and complete, and will fully convey the scope of the disclosure to those skilled in the art. Throughout the disclosure, like reference numerals refer to like parts throughout the various figures and embodiments of the disclosure.

When an autonomous vehicle runs on a road, it is very important to accurately recognize the road and recognize information on various objects printed on the road such as a lane, a stop line, a direction indicator line, and a crosswalk. A method for obtaining a road image by using an existing monocular camera and finding object information included in a road surface from the obtained image is possible only in a case where there is no another vehicle in front of a vehicle being run, and when a road is hidden by a vehicle, an object recognition error may occur due to an image of the vehicle. For example, when the color of a front vehicle being run is white, if a road object is recognized without removing the vehicle from an image, a white bumper of the vehicle may be frequently recognized as a stop line.

When the color of a vehicle and the color of a road are different from each other, the vehicle may be removed only by a monocular camera, but when the color of a vehicle and the color of a road are similar to each other, the removal of the vehicle is difficult and in a dark environment, since color information almost disappears, the removal of the vehicle is more difficult. As a consequence, it is difficult to recognize an object printed on a road surface such as a lane, a stop line, and a crosswalk without separating the road surface from a road image.

The present invention relates to a method and an apparatus for recognizing a road surface from a road image including a front vehicle being run, separating the road surface from the road image, and recognizing an object of the road surface from the recognized road surface. When only the road surface is separated from the road image including the vehicle and an object is recognized from only the separated road surface, it is possible to reduce a road surface object recognition error as compared with a case where an object of the road surface is recognized from the road image including the vehicle.

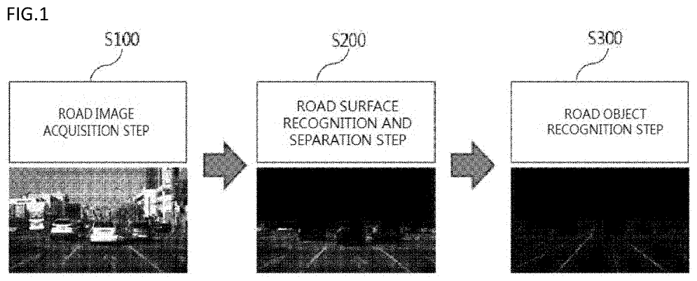

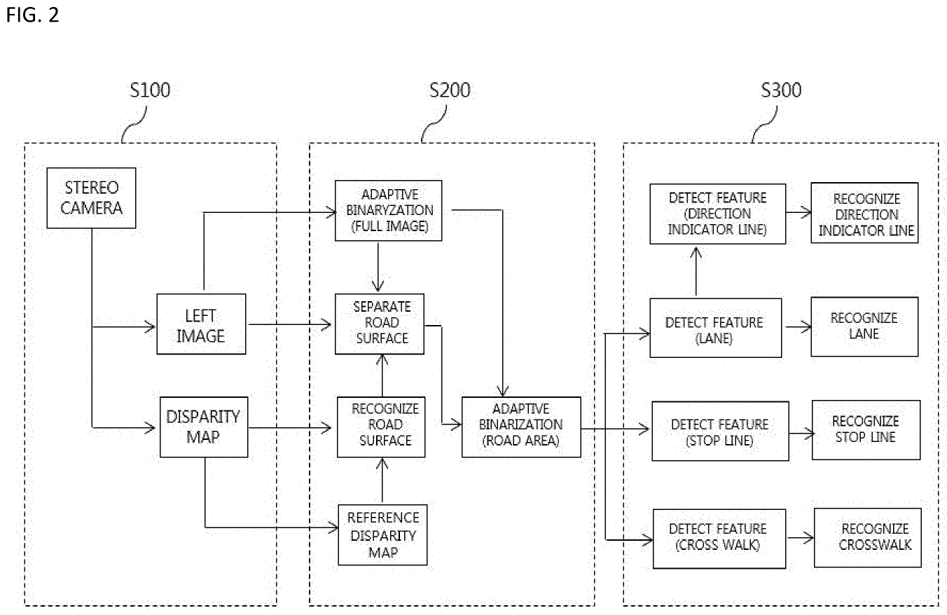

FIG. 1 is a conceptual diagram illustrating a process of a road object recognition method using a stereo camera according to the present invention, and FIG. 2 is a detailed block diagram illustrating the process of the road object recognition method using the stereo camera according to the present invention.

Referring to FIG. 1 and FIG. 2, the road object recognition method using the stereo camera according to the present invention includes a road image acquisition step S100, a road surface recognition and separation step S200, and a road object recognition step S300.

In the road image acquisition step S100, a road image is acquired using the stereo camera. The road image acquired using the stereo camera includes left and right color images of a road and a disparity map.

In the road surface recognition and separation step S200, a road surface is recognized from the road image acquired in the road image acquisition step S100 and is separated from the road image.

The road surface recognition and separation step S200 includes a step S210 of separating a road area by using the disparity map and a reference disparity map, and a step S220 of separating features of the road surface from an input image corresponding to the separated road surface through adaptive binarization.

In the road object recognition step S300, road objects are recognized from the road surface separated in the road surface recognition and separation step S200.

The road object recognition step S300 is performed in sequence of a feature point extraction step S310, a straight line detection step S320, and an object recognition step S330.

That is, feature points of the road objects are extracted using information on the road objects, straight lines are detected using the extracted feature points of the road objects, and road objects are recognized from the detected straight lines.

In the straight line detection step, it is preferable to detect the straight lines by applying a RANSAC algorithm to the extracted feature points of the road objects. In the object recognition step, the objects of the road are recognized using directionality and slopes of respective objects such as a lane, a stop line, a direction indicator line, and a crosswalk among the detected straight lines.

Hereinafter, the process of the road object recognition method using the stereo camera according to the present invention will be described in detail.

Objects printed on a road surface may include a lane, a stop line, a crosswalk, a direction indicator line and the like, and since the objects are very important elements for determining the running of an autonomous vehicle, autonomous driving is possible only when the objects are stably detected regardless of the presence or absence of a vehicle in front of a road.

In order to separate only the road from a road image including a front vehicle being run, 3D information on a space in front of a vehicle is required. That is, since the road is a plane and a vehicle on the road protrudes from the road, it is possible to easily remove the vehicle when 3D information on the road is recognized. It may be possible to use a point that the color of the vehicle and the color of the road is different from each other, but when the color of the vehicle and the color of the road is similar to each other or color information is not sufficient at night, road separation is not easy.

In the case of a person, binocular parallax information obtained through both eyes is automatically processed in the second step of the visual cortex of the brain and the 3D of a space is recognized. Since both eyes are slightly spaced apart from each other, when a person sees the same object, both eyes have different binocular parallaxes depending on distance. Since the binocular parallax occurs due to the positions of the eyes slightly spaced apart from each other from side to side with respect to the same object, the binocular parallax of a near object is larger than that of a remote object.

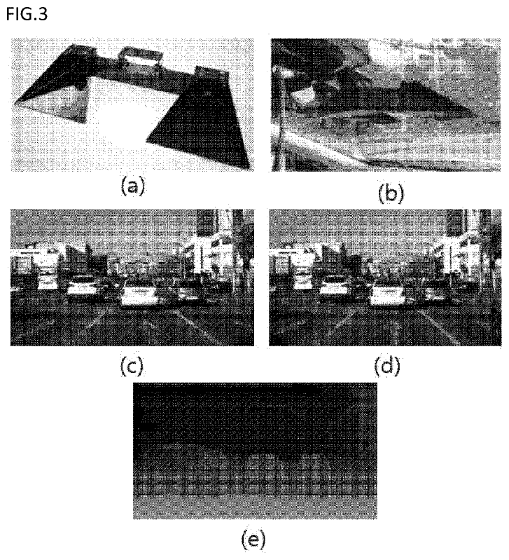

FIG. 3 is a diagram illustrating a stereo camera of a road object recognition apparatus according to the present invention and images acquired from the stereo camera.

As illustrated in (a) and (b) of FIG. 3, a vehicle stereo camera includes two cameras positioned slightly spaced apart from each other similarly to person's eyes and acquires a left image c and a right image d of a road by using the two cameras. The images obtained from the two cameras have different binocular parallax values depending on distance. Such a binocular parallax is called a disparity and binocular parallax values calculated for all points (pixels) of an image is called a disparity map. That is, a disparity map e indicates a disparity of all pixels included in the image, that is, a binocular parallax image.

The disparity map is normally indicated by “D” and has a relation of Equation 1 below with a distance z from the camera and to an object, a distance B (baseline) between the right and left cameras, and a lens focal length F.

Z=B×F/D (1)

That is, when the value of the disparity D increases, the value of the distance z from the camera and to the object decreases. In the disparity map image expressed by brightness values, a bright part (a large disparity value) is near the camera as compared with a dark part (a small disparity value). Actually, in a disparity map obtained from a road image, when there is a vehicle on a road, a disparity value corresponding to the vehicle is displayed brighter than a disparity value corresponding to a part hidden by the vehicle. A part brighter than a disparity brightness value corresponding to a road surface may be determined to correspond to the vehicle. That is, when a part having a value larger than a disparity value of the road surface is removed, it is possible to easily separate a road area.

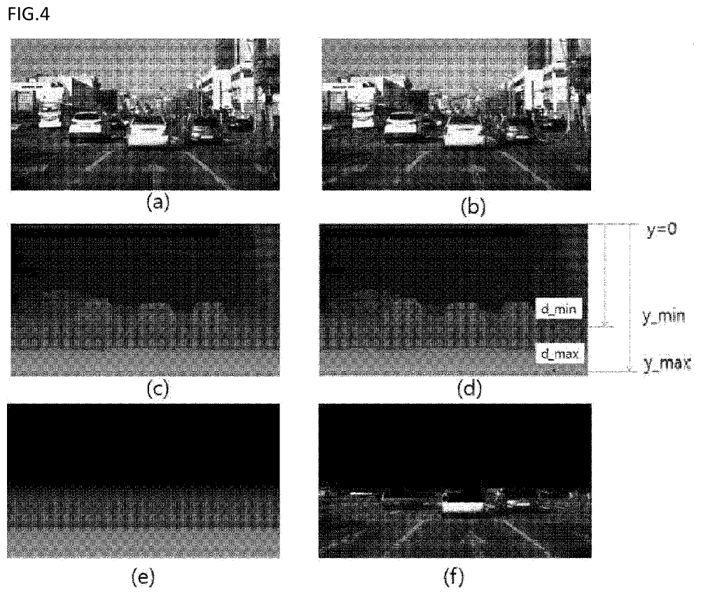

FIG. 4 is a diagram illustrating output images of the stereo camera of the road object recognition apparatus according to the present invention and images excluding the road surface.

With reference FIG. 4, the road surface recognition and separation step S200 of the road object recognition method using the stereo camera according to the present invention will be described.

As illustrated in FIG. 4, disparity values exist in all pixels of an image, are larger in a near object, and are brightly displayed. A distance between the camera and the object can be calculated from the disparity map by using Equation 1 above.

The left side, the right side, and the disparity map are acquired using the vehicle stereo camera, the road surface is recognized using the disparity map, and a color image of the road surface is separated by applying the recognized result to the left color image (or the right color image). In such a case, a road surface separation sequence is as follows.

Firstly, the disparity map is obtained from the stereo camera fixed to and mounted at a vehicle. A disparity value (d_min, y_min) of a point near the vehicle and a disparity value (d_max, y_max) of a point remote from the vehicle are obtained, and then a virtual reference disparity map is calculated.

The reference disparity map is obtained by arbitrary selection of a user from pixel coordinates of points near and remote from the vehicle and an actual disparity map image of a road obtained using the stereo camera, and this process is performed only once when the stereo camera is fixed to the same vehicle and calibration work is performed.

When a difference between an image of the virtual reference disparity map and an output disparity map of the stereo camera is calculated and then the output disparity map D of the stereo camera is larger than the reference disparity map D_ref, a part remaining by removing the image is determined as the road surface.

Removal when (D_D_ref)>0

That is, when a disparity value which can be calculated depending on distance exceeds a reference value, since a part corresponding to the exceeding point is near value camera other than value road, this part may be determined as a vehicle other than the road. Then, an input color image included in an area corresponding to the road surface is used as a road input image to recognize road objects.

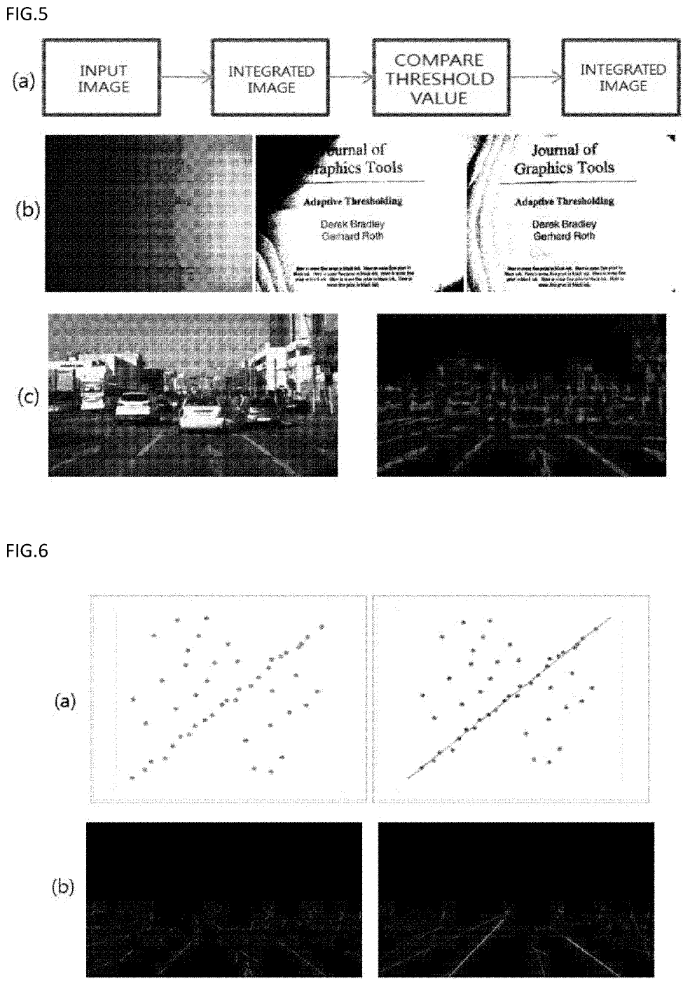

FIG. 5 is a block diagram of the adaptive binarization calculation applied to the road object recognition method using the stereo camera according to the present invention and a diagram illustrating an example applied to an image, and FIG. 6 is a diagram illustrating recognition of a lane using the RANSAC algorithm in the road object recognition method using the stereo camera according to the present invention.

With reference to FIG. 5 an FIG. 6, the road object recognition step S300 of the road object recognition method using the stereo camera according to the present invention will be described.

A process is performed to separate the road surface from the input image and then recognize the road objects from the separated road image. There are various road object recognition algorithms, and the present invention uses adaptive binarization of an input image, feature extraction through object thickness filtering, straight line and line fitting, use of previous measurement results, and the like.

The road object recognition step S300 includes the feature point extraction step S310 of extracting feature points of the road objects by using information on the road objects, the straight line detection step S320 of detecting straight lines by using the extracted feature points of the road objects, and the object recognition step S330 of recognizing objects from the detected straight lines.

The feature point extraction step S310 is a first step for extracting the feature points from the road image in order to recognize the road objects, and image binarization is performed. In the case of the road image, the brightness of the image is not uniform according to various environments such as daylight, night, bright day, cloudy day, an interior of a tunnel, sunset, and rainy day, and the brightness of the road surface is not uniform due to a shadow even in the same image. In such a case, when general binarization is applied, it is not possible to separate features of a lane and the like according to the brightness state of the road surface.

The present invention uses an adaptive binarization method tolerant to an illumination change. (a) of FIG. 5 illustrates an adaptive binarization calculation block diagram and (b) and (c) of FIG. 5 illustrate examples in which the adaptive binarization is applied to a document and a road. Since the adaptive binarization algorithm is well-known, a detailed description thereof will be omitted.

The adaptive binarization process is performed for the road surface and then main feature points for road recognition should be extracted. In the image, feature points indicate special features capable of clearly expressing a recognition target separately from a background, and in the case of a stop line, a crosswalk, and a lane, thickness information and color of a line, an interval, a direction of a straight line, and the like may be main features.

In the present invention, the adaptive binarization process is performed for the road surface, and then basic feature points for recognizing road objects, such as a lane, a stop line, a direction indicator line, and a crosswalk, are extracted utilizing thickness information according to distance.

(a) of FIG. 6 is a diagram illustrating a general example of straight line detection using the RANSAC algorithm, and (b) of FIG. 6 is a diagram illustrating an example of vehicle recognition using feature point data and the RANSAC algorithm for straight lane detection.

Feature points are extracted from the input image and then a linear equation is calculated as the most important information for road object recognition. The linear equation is important information commonly used in a lane, a stop line, and a crosswalk. In the case of the lane, with respect to a travel direction of a vehicle, a slope of a straight line is plus (+) at a left side and is minus (−) at a right side. In the case of the stop line, features, such as a point having a slope of approximate 0, may be used for recognition.

The straight line detection algorithm includes Hough Transform, random sample consensus (RANDSAC) and the like, and the present invention uses the RANSAC algorithm. An example for finding straight lines using the RANSAC algorithm is illustrated in FIG. 6.

In order to recognize objects, physical features of road objects should be utilized. For example, in the case of a lane, there may exist points meeting with each other due to perspective. Features according to objects are summarized as follows.

In the case of a lane, a thickness of the lane, an inter-lane distance, a color, a direction and the like of the lane may be features. As the color of the lane, a white, a yellow, a blue and the like may be applied, and in the direction of the lane, a left direction may be plus and a right direction may be minus.

In the case of a stop line, a thickness, a color, a direction, a position and the like of the line may be features. In the stop line, a color may be specified as a white, a slope may be specified as almost zero, and a position may be specified as a front and the like of a crosswalk. In the case of a crosswalk, a thickness, a color, a direction, a position and the like of the line may be features.

In the case of a direction indicator line, direction indication, such as straight, left turn, right turn, straight and left turn, straight and right turn, and u-turn, and a color, a thickness, a position and the like of the line may be features.

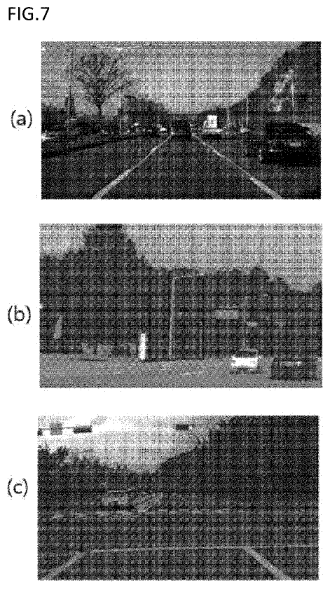

FIG. 7 is a diagram illustrating an example in which road objects are recognized by the road object recognition method using the stereo camera according to the present invention, and illustrates results obtained by recognizing a lane (a), a crosswalk (b), and a stop line (c).

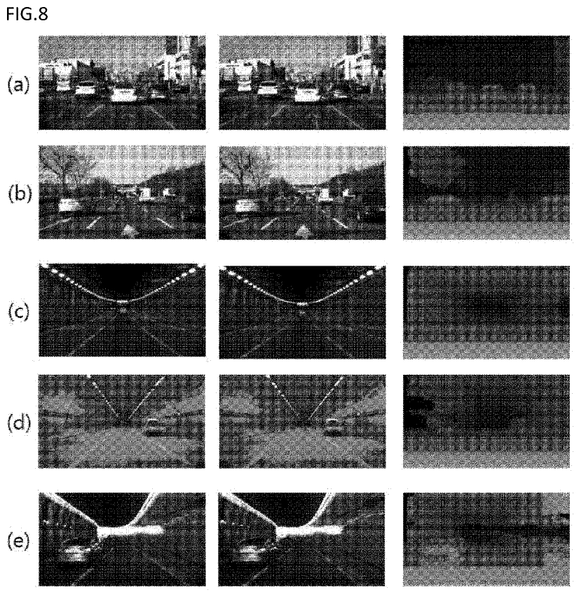

FIG. 8 is a diagram illustrating left and right images of a road acquired from various road environments by using the stereo camera and a disparity map.

(a) of FIG. 8 is an image and a disparity map when there is a front vehicle at clear daylight and (b) of FIG. 8 is an image and a disparity map when there is a front vehicle and a shadow at clear daylight.

(c) of FIG. 8 is an image and a disparity map when white light has intermediate brightness in a tunnel, (d) of FIG. 8 is an image and a disparity map when there is a front vehicle in the bright illumination of red light in the tunnel, and (e) of FIG. 8 is an image and a disparity map when escaping from the tunnel with the bright illumination of the red light.

Meanwhile, the road object recognition apparatus using the stereo camera according to the present invention includes the stereo camera, a road image acquisition unit that acquires a road image by using the stereo camera, a road surface recognition and separation unit that recognizes a road surface from the acquired road image and separates the road surface, and a road object recognition unit that recognizes road objects from the separated road surface.

The road image acquisition unit acquires left and right color images of a road and a disparity map by using the stereo camera in realtime.

The road surface recognition and separation unit separates a road area by using the disparity map and the reference disparity map, and separates features of the road surface from an input image corresponding to the separated road surface through the adaptive binarization.

The road object recognition unit extracts feature points of the road objects by using thickness and color information on the road objects, detects straight lines by applying the RANSAC algorithm to the extracted feature points of the road objects, and recognizes objects by using directionality and slope information on respective objects, which includes a lane, a stop line, a crosswalk, or a direction indicator line, of the detected straight lines.

While various embodiments have been described above, it will be understood to those skilled in the art that the embodiments described are by way of example only. Accordingly, the disclosure described herein should not be limited based on the described embodiments.

What is claimed is:

1. A road object recognition method using a stereo camera, comprising:
a road image acquisition step of acquiring a road image by using the stereo camera;
a road surface recognition and separation step of recognizing a road surface from the acquired road image and separating the road surface; and
a road object recognition step of recognizing a road object from the separated road surface,
wherein the road image acquisition step is a step in which left and right color images of a road and a disparity map are acquired using the stereo camera in realtime, and
the road surface recognition and separation step comprises:
a step of separating a road area by using the disparity map and a reference disparity map; and
separating a features of the road surface from an input image corresponding to the separated road surface through adaptive binarization.

2. The road object recognition method using the stereo camera according to claim 1, wherein the road object recognition step comprises:
a feature point extraction step of extracting a feature point of the road object by using information on the road object;
a straight line detection step of detecting a straight line by using the extracted feature point of the road object; and
an object recognition step of recognizing an object from the detected straight line.

3. The road object recognition method using the stereo camera according to claim 2, wherein, in the feature point extraction step, the feature point of the road object is extracted using thickness and color information on the road object.

4. The road object recognition method using the stereo camera according to claim 2, wherein, in the straight line detection step, the straight line is detected by applying a RANSAC algorithm to the extracted feature point of the road object.

5. The road object recognition method using the stereo camera according to claim 2, wherein, in the object recognition step, the object is recognized using directionality and slope of each object of the detected straight line.

6. The road object recognition method using the stereo camera according to claim 5, wherein each object includes a lane, a stop line, a crosswalk, or a direction indicator line.

7. A road object recognition apparatus using a stereo camera, comprising:
the stereo camera;
a road image acquisition unit that acquires a road image by using the stereo camera;
a road surface recognition and separation unit that recognizes a road surface from the acquired road image and separates the road surface; and
a road object recognition unit that recognizes a road object from the separated road surface,
wherein the road image acquisition unit acquires left and right color images of a road and a disparity map by using the stereo camera in realtime, and
the road surface recognition and separation unit separates a road area by using the disparity map and a reference disparity map, and separates a feature of the road surface from an input image corresponding to the separated road surface through adaptive binarization.

8. The road object recognition apparatus using the stereo camera according to claim 7, wherein the road object recognition unit extracts a feature point of the road object by using thickness and color information on the road object, detects a straight line by applying a RANSAC algorithm to the extracted feature point of the road object, and recognizes an object by using directionality and slope information on each object, which includes a lane, a stop line, a crosswalk, or a direction indicator line, of the detected straight line.
